(19) United States
(12) Patent Application Publication
(10) Pub. No.: US 2009/0173257 A1
(43) Pub. Date: Jul. 9, 2009

(54) HYBRID FEED MECHANISM

(76) Inventor: Peter Stein, Kent (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/295,590

(22) PCT Filed: Mar. 30, 2007
(86) PCT No.: PCT/GB2007/001150

§ 371 Date: Sep. 30, 2008

(30) Foreign Application Priority Data
Apr. 6, 2006 (GB) 0606898.5

(51) Int. Cl. F23K 3/12; F16K 3/00

(52) U.S. Cl. 110/109; 251/327

(57) ABSTRACT

A feed mechanism in which a ram (2) fed from a hopper (1) compresses a fuel against a closed valve (11) which is then opened for the ram to push the fuel towards a rotary scroll (6) for delivery to a processing vessel.

Conventional ram feeders used to inject a fuel into a processing vessel have a problem with certain fuel types having a tendency to compact in a manner that jams the feeder and stops the flow of fuel into the vessel. This is particularly a problem with larger ram units and can result in serious process problems. The present invention has been designed to provide a solution to this problem with particular regard to the feeding of fuels into a rotating anaerobic gasifier vessel. However, other the feed mechanism is not limited to use in gasifiers. Fuel is compressed by a ram against a closed valve to form a pellet which acts as a compact fuel and also a barrier to prevent ingress of air. In certain cases it may be necessary to provide a cutter, preferably a rotary cutter between the guillotine valve and the scroll tube to break up the fuel pellet and assist the delivery of fuel into the scroll feeder. However, a preferred version of the invention incorporates a chamber between the ram feeder and the scroll feeder to receive the fuel from one or more ram feeders before delivery to the scroll feeder to assist in the fuel breakdown process. The introduction of this chamber in most cases obviates the need for a rotary cutter. It must be noted that the feeder mechanism is not limited to feeding a gasifier, but can be used in a wide variety of process vessels. A further benefit is that more than one ram can be incorporated to increase or vary the fuel supply and even out its flow.

By way of example only, a specific embodiment of the present invention with and without an intermediate chamber will now be described with reference to the accompanying drawings in which:

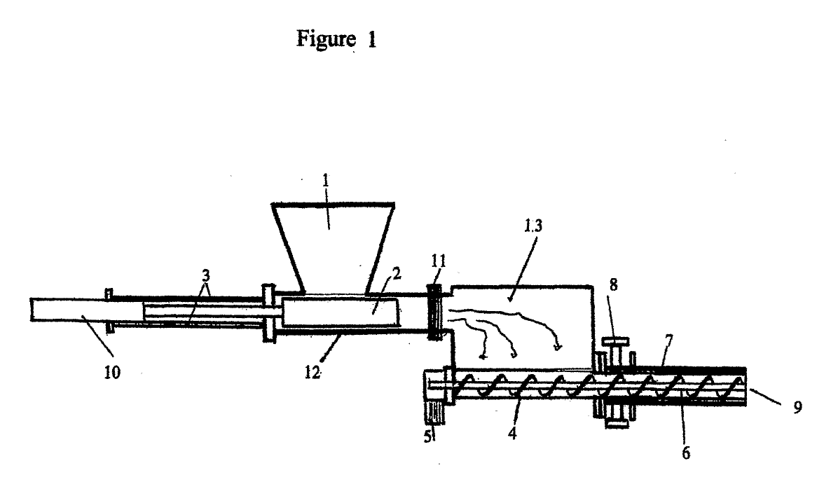

FIG. 1 is a side view of the feeder mechanism with intermediate chamber and single ram feed.

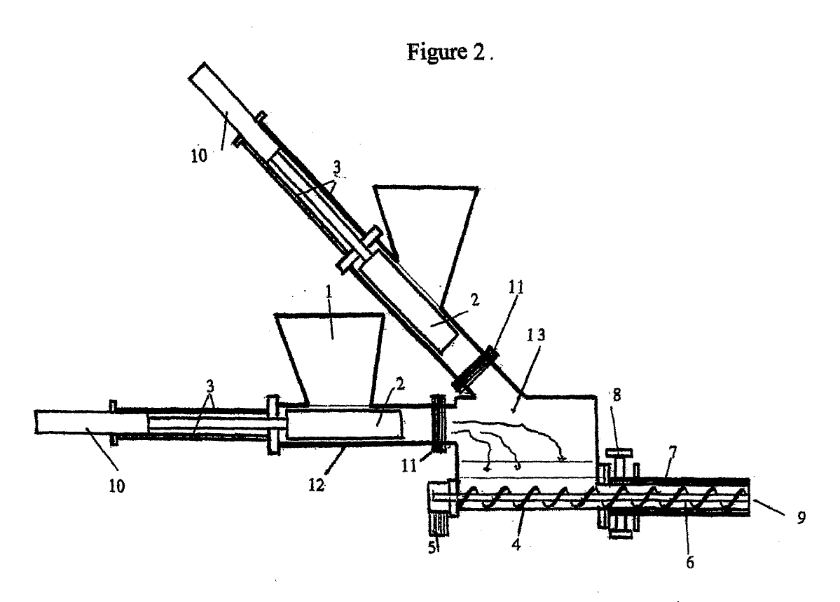

FIG. 2 is a side view of the feeder mechanism with intermediate chamber and two ram feeds.

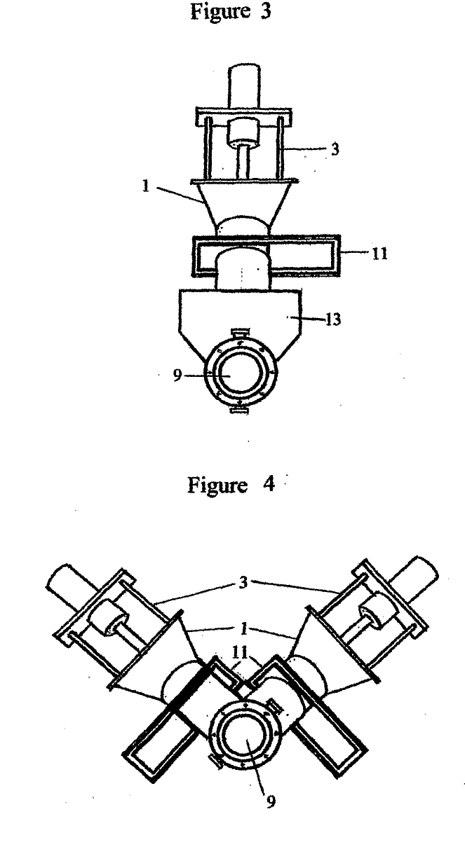

FIG. 3 is a view from the outlet end of the feeder mechanism with intermediate chamber.

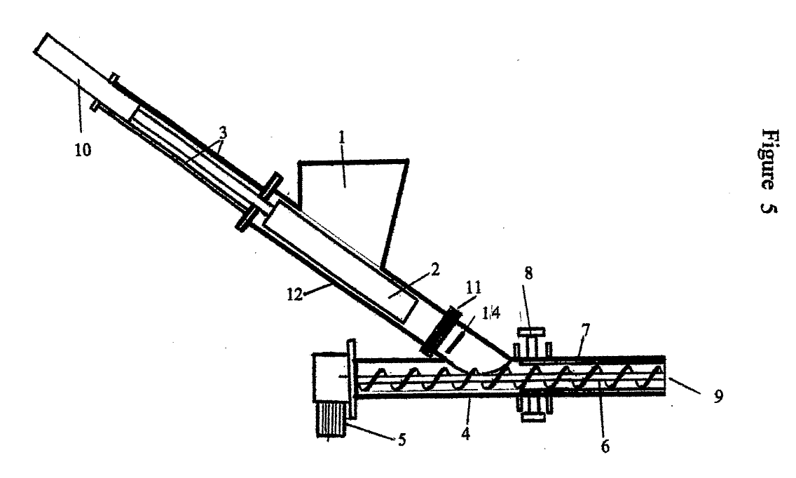

FIG. 4 is a similar view of a feeder with two rams feeding a single scroll, one open one closed without intermediate chamber.

FIG. 5 is a side view of a feeder without intermediate chamber.

Shredded and dried fuel is delivered into a feed hopper 1 whence it is gravity fed into a ram tube 12 whilst the feeder ram 2 is retracted by a hydraulic ram 10 along guides 3. The feeder ram 2 is returned to press the fuel charge against a closed guillotine valve 11. The guillotine valve then opens and the fuel pellet is pushed by the feeder ram towards the scroll tube 4 containing scroll 6 driven by a power unit 5 Because of the high temperature in the gasifier retort, the part of the feeder inserted into the gasifier is cooled by water introduced through inlet 8 into a cooling jacket 7. The fuel is ejected from the scroll drive at the tube end 9 into the gasifier. In the preferred embodiment of the invention, an intermediate chamber (13) is provided between the ram feeder and the scroll

More than one feed ram can be connected to the intermediate chamber or scroll feeder, and this gives the advantage of a possible variation of fuel supply and a smoothing of flow of fuel to the scroll. In addition, a rotary cutter (14) can be fitted between the guillotine valve and the scroll tube to improve the fuel flow

Whilst the invention has been described in terms of a specific embodiment thereof, it will be apparent that various changes and modifications can be made by one skilled in the art without departing from the spirit and scope thereof.

1. A feed mechanism in which a ram fed from a hopper compresses a fuel against a closed valve which is then opened for the ram to push the fuel towards a rotary scroll for delivery to a processing vessel

2. A feed mechanism as claimed in claim 1 in which the valve is a sliding guillotine valve.

3. A feed mechanism as claimed in claim 1 or claim 2 in which the ram feeds into an intermediate chamber provided between the valve and the scroll to assist the break up of the fuel before entry to the scroll feeder.

4. A feed mechanism as claimed in any of the previous claims in which there are two or more rams connecting to a single scroll feeder.

5. A feed mechanism as claimed in any of the previous claims in which a cuffing device is provided between the valve and the scroll to break up the fuel before entry to the scroll feeder.

6. A feed mechanism as claimed in claim 4 in which the cutting device is a rotary cutter.

7. A vessel as claimed in any of the previous claims in which the outlet pipe is water cooled.
